(19) United States
(12) Patent Application Publication
(10) Pub. No.: US 2021/0323471 A1
(43) Pub. Date: Oct. 21, 2021

(54) METHOD AND ARRANGEMENT FOR GENERATING A REPRESENTATION OF SURROUNDINGS OF A VEHICLE, AND VEHICLE HAVING SUCH AN ARRANGEMENT

(71) Applicants: VOLKSWAGEN AG, Wolfsburg (DE); AUDI AG, Ingolstadt (DE)

(72) Inventors: Alexander URBAN, Gifhorn (DE); Georg MAIER, Hepberg (DE); Sascha ZIEBART, Braunschweig (DE); Frank SCHWITTERS, Königslutter (DE); Gordon SEITZ, Ehra (DE)

(21) Appl. No.: 17/271,622

(22) PCT Filed: Aug. 9, 2019
(86) PCT No.: PCT/EP2019/071391

§ 371 Date: Feb. 26, 2021

(30) Foreign Application Priority Data
Aug. 31, 2018 (DE) 10 2018 214 875.9

(51) Int. Cl. B60R 1/00; B60K 35/00; G06K 9/00

(52) U.S. Cl. CPC B60R 1/00; B60K 35/00; G06K 9/00791; B60K 2370/176; B60R 2300/301; B60R 2300/20; B60R 2300/802

(57) ABSTRACT

A method for generating a representation of surroundings of a transportation vehicle including determining a height profile of a vehicle surroundings; capturing image information of the vehicle surroundings; projecting the image information onto at least a part of a projection screen for generating the representation of surroundings, wherein the projection screen is produced in a raised state at least in regions where the determined height profile displays a correspondingly raised structure of the vehicle surroundings; and generating a surroundings map of the transportation vehicle based on the representation of surroundings by which a surroundings region of the transportation vehicle is imaged, which is larger than a detection range of sensors used for determining the height profile and/or the image information. Also disclosed is an arrangement for generating a surroundings representation of a transportation vehicle and a transportation vehicle utilizing an arrangement.

### PRIORITY CLAIM

This patent application is a U.S. National Phase of International Patent Application No. PCT/EP2019/071391, filed 9 Aug. 2019, which claims priority to German Patent Application No. 10 2018 214 875.9, filed 31 Aug. 2018, the disclosures of which are incorporated herein by reference in their entireties.

### SUMMARY

Illustrative embodiments relate to a method and an arrangement for generating a representation of surroundings of a transportation vehicle, and to a transportation vehicle comprising such an arrangement.

### BRIEF DESCRIPTION OF THE DRAWINGS

An exemplary embodiment is explained below with reference to the accompanying schematic figures, in which:

FIG. 1A illustrates a schematic illustration of a transportation vehicle, comprising an arrangement in accordance with an exemplary embodiment, wherein the arrangement captures the transportation vehicle surroundings;

FIG. 1B illustrates a schematic illustration of a projection screen produced based on the capturing from FIG. 1A; and

FIG. 2 shows a flowchart for an exemplary method.

### DETAILED DESCRIPTION

The use of representations of surroundings in transportation vehicles is known. These are generally used to inform a driver about a current operating situation of the transportation vehicle and, in particular, to provide the driver with a representation of the current transportation vehicle surroundings. This can be effected, e.g., by a display device in the transportation vehicle interior, on which the representation of surroundings is displayed.

The prior art includes approaches for creating representations of surroundings by vehicle-mounted cameras. In that case, the representation of surroundings can be created and displayed as a so-called top or bird view perspective, in which a modeled representation of the transportation vehicle itself is often inserted for orientation purposes (for example, in the center of the image). To put it another way, representations of surroundings are known in which a model of the transportation vehicle in top view and also the transportation vehicle surroundings are represented, wherein the transportation vehicle surroundings are imaged on the basis of the captured camera images. Such a solution is offered by the present applicant under the designation “Area View”.

The representation of surroundings is typically merged from images captured by a plurality of vehicle-mounted camera devices. For this purpose, approaches are known in which a (virtual) projection screen is produced and the images are projected into this projection screen, the images of a plurality of cameras, in the case of correspondingly simultaneous projection, being combined to form the representation of surroundings. In this case, the projection is effected, for example, according to the known installation positions and/or viewing angles of the camera devices.

DE 10 2010 051 206 A1 discloses in this context the merging of a plurality of partial images to form a larger region exceeding the partial images, wherein additional symbols (so-called artificial image elements) can also be inserted. Further technological background exists in DE 10 2015 002 438 A1, DE 10 2013 019 374 A1, DE 10 2016 013 696 A1 and DE 603 18 339 T2.

As outlined, a (virtual) projection screen can be defined for the purpose of creating the representation of surroundings on the basis of camera images. The projection screen is typically defined as a horizontal spatial plane and/or as a surface beneath the transportation vehicle. This is based on the concept that the cameras are at least proportionally likewise directed at the surface beneath the transportation vehicle, for example, through the choice of a corresponding viewing angle, and thus captured images can also be projected back again onto the surface beneath the transportation vehicle. This constitutes a comparatively simple solution for creating the representation of surroundings in which satisfactory results can be achieved particularly in direct proximity to the transportation vehicle. In certain situations, however, this approach can result in distortions, which reduces the representation quality. Therefore, it is alternatively known for the projection screen to be embodied as curved, which is also referred to as a projection “bowl”. In both cases, the projection screen is intrinsically embodied as planar, however, and extends as a two-dimensional flat or curved structure around the transportation vehicle or around the inserted transportation vehicle model. It has been found that even the use of a curved projection screen does not always result in a realistic and intuitively comprehensible representation of surroundings. Moreover, hitherto only comparatively small surroundings regions have been able to be imaged as a representation of surroundings, which likewise reduces the information content and hence the quality.

Therefore, the problem addressed is that of improving the quality of a representation of surroundings for a transportation vehicle.

Disclosed embodiments provide a method, an arrangement and a transportation vehicle. It goes without saying that the options and features discussed in the introduction can also be provided in the present disclosure, unless something to the contrary is indicated or evident.

A basic concept of the disclosed embodiments consists in adapting the projection screen to the transportation vehicle surroundings. In a departure from the prior art, here the intention is to enable the projection screen to be configured no longer as exclusively flat or uniformly curved. In regions with raised structures within the transportation vehicle surroundings, the projection screen is intended to be embodied likewise as (locally) raised. It has been found that, in comparison with projection screens used hitherto, distortions within the representation of surroundings can thereby be reduced, for example, in comparison with the previous case in which structures which are captured in the camera images and in reality are raised are projected onto flat or curved projection screens.

Furthermore, the disclosed embodiments provide not just for generating a representation of surroundings in the immediate vicinity of the transportation vehicle, but rather for generating on the basis thereof a (virtual) environment map which covers a region which is larger than the capture region of sensors used for determining the representation of surroundings (i.e., is larger than the sensor-related capture region or the capture region when the transportation vehicle is stationary). The representation of surroundings can be used to texture, to generate and/or to supplement an environment map continuously during travel of the transportation vehicle. Therefore, in principle, the environment map can have a variable size or generally be generatable as a data collection of variable size. By way of example, according to the collected or generated representations of surroundings, the environment map can be continuously supplemented and enlarged, for example, up to an optional maximum size. The environment map can be generated and supplemented along a transportation vehicle travel distance of a length of at least 5 m, at least 10 m, or at least 20 m, for example. As a circular buffer or else according to the so-called FIFO principle (First in First Out), regions of the environment map which, optionally counter to the current direction of travel or relative to the current direction of travel, are situated behind the transportation vehicle can be erased and new regions of the environment map, optionally situated in the direction of travel, can be supplemented. This can be done by corresponding erasure and supplementation of information for these regions. The environment map (or the surroundings region covered thereby) can thus be moved as it were jointly with the transportation vehicle relative to the surroundings.

Furthermore, the transportation vehicle can be positionable in various ways within the environment map and/or it is possible for the environment map not to be fixed with respect to the transportation vehicle or not to be generated purely centrally around the transportation vehicle.

In detail, a method for generating a representation of surroundings of a transportation vehicle is proposed, comprising:

determining a height profile of vehicle surroundings;

capturing image information of the vehicle surroundings;

projecting the image information onto a projection screen for generating the representation of surroundings,

wherein the projection screen is produced in a raised manner at least regionally if the height profile determined indicates a correspondingly raised structure of the vehicle surroundings; and

generating an environment map of the transportation vehicle on the basis of the representation of surroundings, wherein, by the environment map, a surroundings region of the transportation vehicle is able to be imaged (and/or is imaged) which is larger than a capture region of sensors used for determining the height profile and/or the image information.

By way of example, the surroundings region imaged by the environment map can comprise a size at least one and a half times, at least two times, at least three times, or at least four times, that of the sensor capture region, the respective regions optionally being considered as areas (for example, in a horizontal spatial plane or along the surface beneath the transportation vehicle).

It goes without saying that a single sensor generally only captures either the height profile or the image information. Furthermore, a capture region of a sensor can be understood to mean a region within which evaluable signals and/or signals which satisfy a predetermined quality criterion (e.g., having a signal-to-noise ratio of at least 0.5 or at least 0.7) are able to be captured.

The representation of surroundings can be a virtual and/or digital representation of surroundings. A representation generated as or on the basis of image and/or video files can be involved. The representation of surroundings can be displayable on a display device, in particular, in a transportation vehicle interior. A displayable segment of the representation of surroundings can correspond to a capture region of the sensors. The environment map can generally image a larger surroundings region than is displayable on the display device.

Generally, a complete three-dimensional profile of the vehicle surroundings can be captured, for example, by (environment) sensor devices explained above. At the very least, however, a height profile of the vehicle surroundings should be captured, that is to say an extent of structures of the vehicle surroundings in a vertical spatial direction, wherein the vertical spatial direction optionally extends orthogonally to the surface beneath the transportation vehicle. It goes without saying that the dimensions of the height profile that is able to be captured (or else of the complete three-dimensional profile of the vehicle surroundings) may be limited, e.g., by the sensor devices used and the capture regions thereof.

The (optionally three-dimensional) height profile can be present as a file and/or can be a digital information collection which images, for example, the surroundings as a (measurement) point correction and/or a grid model. The disclosed embodiments accordingly generally provides for producing the projection screen according to the height profile (i.e., for shaping the projection screen analogously to the height profile (optionally three-dimensionally)). The projection screen and thus indirectly the environment map can then be textured with the image information. To put it another way, the representation of surroundings can also be referred to as a height profile textured with image information and/or the environment map can be generated or compiled on the basis of a representation of surroundings which images different surroundings regions.

The captured image information can be video information and/or a video image data stream. Accordingly, the representation of surroundings can be continuously updated and/or generated, for example, by new (i.e., currently captured) image information being continuously fed in. To generate the representation of surroundings, with the use of image information captured by different camera devices, optionally items of image information which were captured or recorded at the same capture time are projected simultaneously.

As outlined, the projecting can comprise arranging the image information in or on the projection screen, which can generally be effected in a computer-aided manner. In this case, it is possible to have recourse to information concerning the system set-up and, in particular, the position and/or orientation of camera devices used for image capture.

Embodying the projection screen in a raised manner can be understood to mean an at least regional extent in a non-horizontal direction and/or direction extending at an angle with respect to the (virtual) surface beneath the transportation vehicle. By way of example, the projection screen can extend vertically at least regionally. Expressed in general terms, embodying the projection screen in a raised manner can result in the projection screen being embodied three-dimensionally, wherein the raised regions can rise up from, for example, an initial plane of the projection screen or extend at an angle thereto. Raised regions can be shaped, for example, like projections or as protruding regions, e.g., relative to an abovementioned initial plane or base plane of the projection screen. By virtue of raised regions being provided, the projection screen can have edges, bends and/or angles at least regionally. As a consequence of the raised regions, the projection screen can have regions extending at an angle to one another and/or regions extending parallel to one another (and, in particular, planes) at different height levels.

The method can optionally comprise determining raised regions in the height profile and locally modifying the projection screen for at least selected regions from among the regions from an extent that initially or as standard is planar (or horizontal), in particular, the projection screen extends there analogously to the raised regions of the height profile or the environment map (e.g., vertically).

Furthermore, generally it is also possible to determine a position of the transportation vehicle within the environment map. For this purpose, in a manner known per se, it is possible to have recourse to odometry information captured or imaged by way of wheel movements, for example. Furthermore, a steering angle and/or a transportation vehicle inclination can be captured and taken into account. It is likewise possible to have recourse to information from navigation systems (in particular, locating information), wherein such information can be generated on the basis of GPS signals, for example. However, preference is given to an option without the aid of such information and, in particular, GPS signals, for example, to be independent of current reception conditions for such signals.

This can also be utilized to the effect that corresponding location information can likewise be assigned to the image information captured. In this case, it is beneficial if a sensor (e.g., a camera device) used for capturing the image information is and remains positioned in the same way within the transportation vehicle (i.e., is positioned therein at a place that remains the same, and/or is oriented in a constant manner and thus has a constant viewing angle). On the basis of this, for example, a transportation vehicle position can be converted into a position of the camera devices and/or corresponding location information can be assigned to the image information captured.

In an analogous manner, corresponding location information can also be assigned to regions of the environment map and/or of the height profile, wherein, for example, it is possible to have recourse to a position of the sensor device for generating the environment map (for example, distance sensors) and a transportation vehicle position determined can be converted into a position of the sensor device. Information captured thereby (in particular, regions of the environment map and/or of the height profile captured thereby) can then likewise be provided with location information.

Generally, therefore, regions of the environment map and/or of the height profile and also image information captured can be provided with location information, such that it is also possible to determine which items of image information relate to which regions of the environment map and/or of the height profile.

It goes without saying that such location information can also be used as location information for the representation of surroundings. A region of the representation of surroundings which images a specific surroundings region can be assigned an item of location information relating to this surroundings region, e.g., on the basis of the item(s) of image information used. To generate the environment map, a plurality of such regions of the representation of surroundings can be merged according to location information.

Optionally, the image information is captured by at least one vehicle-mounted camera device, which constitutes a type of sensor for generating the representation of surroundings. In accordance with one option, at least three or at least four camera devices can be provided, which can be distributed around the transportation vehicle, for example, such that cameras may be provided at each side of the transportation vehicle (i.e., at the front and rear sides and also at the two outer sides comprising the entry doors). Consequently, the representation of surroundings can correspond to a so-called “surround” or 360° viewing. As mentioned, the image information can be provided as video data and/or as an image data stream and the camera devices can correspondingly be embodied as video cameras.

The height profile (or the environment map) can be generated at least partly on the basis of information captured by sensors of at least one vehicle-mounted (environment) sensor device, wherein the vehicle-mounted sensor device may be a sensor device among those that are different than the camera devices. The sensor device can be configured to capture the vehicle surroundings without taking as a basis measured ambient light intensities, thus in contrast to normal practice in the case of camera devices. By way of example, the sensor device can be one of the following: a distance measuring device, a radar device, a lidar device, an ultrasonic device, an optical distance measuring device (for example, on the basis of laser radiation).

In accordance with at least one exemplary embodiment, the image information is used for producing an at least regional texture of the projection screen. To put it another way, therefore, at least one region of the projection screen can be textured on the basis of or by the image information. This can be effected by projecting the image information, wherein at the impingement regions of the image information on the projection screen a corresponding texturing or, in other words, imaging of the image information at this region as a corresponding texture can be effected.

In a further disclosed embodiment, in at least selected (in particular, raised) regions of the projection screen, texturings can be effected by predetermined filling information instead of the image information. In the context of the present disclosure, provision can generally be made firstly for projecting all image information onto the projection screen (e.g., in relation to a predefined point in time) and then for subsequently adapting the content of the projection screen (e.g., by regionally masking out or overwriting the image information projected onto the projection screen). Alternatively, provision can be made for determining from the outset regions of the projection screen onto which the image information is not intended to be projected or in which different information than the image information is intended to be represented.

In the context of the method, therefore, provision can also be made for determining regions of the projection screen for a texturing by the predetermined filling information instead of the image information. This can be effected depending on the height profile determined. By way of example, on the basis of the height profile, it is possible to determine regions at which projection of image information would be expected to result in losses of quality and instead the intention is to have recourse to the predetermined filling information. This can involve raised regions or regions concealed by raised regions (from the point of view of the transportation vehicle).

In one development, in at least one region of the projection screen (that is to say is concealed by the raised region) situated behind a raised region of the projection screen from the point of view of the transportation vehicle, a texturing is effected by the predetermined filling information instead of the image information. That is based on the concept that meaningful image information is not able to be determined for this region since it is concealed by the raised region (or the raised structure of the height profile that underlies the region) from the view of the camera. To increase the meaningfulness of the representation of surroundings, predetermined filling information can be used which, for example, also serves only to make a driver aware that meaningful image information is not present for the corresponding region.

In this context, the filling information can comprise at least one of the following:

a predefined color (e.g., black or white);

a predefined pattern;

a texturing predefinition for an object recognized in the at least one region.

In the latter case, an object present in the region can be recognized and classified on the basis of known image evaluation algorithms and, e.g., on the basis of previously stored object classes (e.g., comprising traffic signs, transportation vehicle types, components such as curbs or sidewalks). The object can thereupon be represented by other filling information (or a texturing predefinition) instead of the actual image information. This can increase the meaningfulness of the representation of surroundings from the point of view of the driver since for the driver frequently recurring features are always displayed in the same way on the basis of the texturing predefinition and the content of the representation of surroundings is thus able to be understood rapidly and intuitively.

The disclosure furthermore relates to an arrangement for generating a representation of surroundings of a transportation vehicle, comprising:

at least one sensor device for capturing information for generating a height profile of the vehicle surroundings;

at least one camera device for capturing image information of the vehicle surroundings; and

a representation of surroundings generating device configured to carry out the following operations:

determining a height profile of vehicle surroundings;

producing a projection screen for the representation of surroundings on the basis of the height profile;

projecting the image information onto at least one part of the projection screen for generating the representation of surroundings,

wherein the projection screen can be produced in a raised manner at least regionally if the height profile determined indicates a correspondingly raised structure of the vehicle surroundings, and

wherein the representation of surroundings generating device is furthermore configured for generating an environment map of the transportation vehicle on the basis of the representation of surroundings, by which a surroundings region of the transportation vehicle is able to be imaged which is larger than a capture region of the sensor device and of the camera device.

All of the features and developments above and below explained in association with the method can likewise be provided for the arrangement. The arrangement can be configured to carry out a method in accordance with any of the disclosed embodiments above and below.

Furthermore, the disclosed embodiments relate to a transportation vehicle comprising an arrangement of the above type.

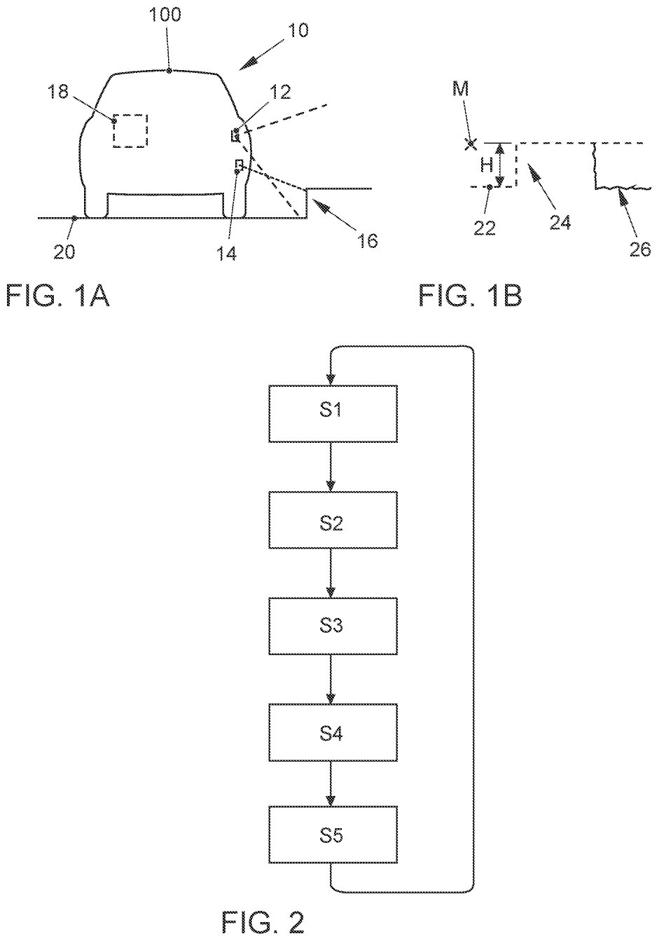

FIG. 1A shows a transportation vehicle 100 comprising an exemplary arrangement 10, which arrangement carries out a disclosed method. The transportation vehicle 100 is shown schematically in a frontal view, such that the viewing axis corresponds to a view of the front side or front of the transportation vehicle. It is evident that in a side region (e.g., on a side mirror, not illustrated separately, and thus not directly on the front side facing the observer), the transportation vehicle 100 comprises a camera device 12 and a further sensor device 14 as a distance measuring device (e.g., an ultrasonic sensor device, which can also be arranged in the region of a fender).

The camera device 12 has a conically expanding capture region indicated by dashed lines, although on account of a decreasing resolution with increasing distance, it is not possible for regions arbitrarily far away to be captured with a desired quality. In a manner known per se, the sensor device 14 captures distances to structures in the surroundings by way of ultrasound, which is indicated by a single dashed line in FIG. 1A. The camera device 12 and also the sensor device 14 thus each have a defined capture region (i.e., a capture region of the surroundings), the size of which is limited, in particular, by requirements in respect of the quality of the captured information (for example, to less than 4 m or less than 3 m).

The transportation vehicle 100 comprises, albeit not correspondingly illustrated, at least one camera device 12 and a further sensor device 14 at each side, such that the vehicle surroundings are able to be completely captured both in terms of images and by the sensor devices 14 in the sense of 360° capturing.

FIG. 1A shows a curb 16 as a raised structure (i.e., structure deviating from the purely horizontal spatial plane) laterally with respect to the transportation vehicle 100. The curb is captured both by the camera device 12, which continuously generates video images of the surroundings, and by the sensor device 14, which likewise continuously effects capturing of the surroundings. The camera device 12 and sensor device 14 transmit the captured and optionally also already evaluated information to a representation of surroundings generating device 18, which can, e.g., be integrated into a control unit of the transportation vehicle 100 or be provided as such a control unit.

On the basis of the information captured by the sensor device 14, the representation of surroundings generating device 18 creates a height profile of the surroundings. In this case, it may combine the information of a plurality or else all of the corresponding sensor devices 14 at the individual sides of the transportation vehicle, a corresponding plurality of sensor devices 14 not been shown separated in FIG. 1A. Furthermore, for creating the height profile it is also possible to evaluate captured camera images, e.g., to effect a plausibilization of the measurement signals of the sensor devices 14 and/or to check or to define more precisely limits of raised regions captured thereby (e.g., to verify or to determine a vertical height of the curb 16 in FIG. 1A above the direct surface 20 beneath the transportation vehicle by way of image recognition).

On the basis of this height profile, the representation of surroundings generating device 18 furthermore produces a virtual projection screen 22 (see FIG. 1B), into which it then projects image information captured simultaneously by all camera devices 12 for the purpose of generating the representation of surroundings, in a manner known per se.

FIG. 1B schematically shows a segment of the (virtual) projection screen 22 produced by the representation of surroundings generating device 18. The projection screen can be defined, e.g., as a data set defining the spatial extent of the projection screen 22, e.g., around a virtual vehicle midpoint M (or else a so-called virtual camera). The projection screen 22 is not represented to the driver separately, but rather is only used for generating the representation of surroundings. In a departure from the illustration from FIG. 1B, the projection screen 22 is defined here as a three-dimensional structure and, e.g., also extends into the plane of the drawing in FIG. 1B and in equal proportions to the left of the vehicle midpoint M as well.

It is evident that the projection screen 22 does not have a purely planar shape (i.e., shape extending in a single flat or curved two-dimensional plane). Instead, in the region of the curb 16 it likewise has a raised region 24. The projection screen 22 thus extends analogously to the captured height profile of the vehicle surroundings or is shaped in a manner corresponding thereto. This is manifested in FIG. 1B in the stepped vertical rise of the projection screen 22 corresponding to the captured height profile (i.e., reflecting the uneven height profile caused by the curb 16).

The representation of surroundings generating device 18 uses the projection screen 22 to project thereon the image information captured by the camera device 12. This is effected in accordance with approaches known from the prior art, which in part are explained in the documents outlined in the introduction or are already used in the “Area View” solution offered by the present applicant.

In the context of the projection, the initially not separately textured projection screen 22 (or an environment map corresponding to the height profile) is textured. This means that the image information, by projection, is arranged within the projection screen 22 or is distributed therein, or, in other words, fills it.

By virtue of the fact that, according to the captured height profile, the projection screen 22 can likewise be embodied in a raised manner, it is possible to reduce distortions that occurred in the course of previous projection into a purely horizontal plane (for example, into a plane corresponding to the surface 20 beneath the transportation vehicle from FIG. 1A). The disclosed embodiments thus make possible a higher quality of the representation of surroundings since the latter is realistic and more easily comprehensible for the driver.

The representation of surroundings obtained in this way can be displayed to a driver in a display device in the transportation vehicle interior. This may be effected as a so-called bird view perspective or top view of the transportation vehicle, in which the transportation vehicle is inserted as a symbol. Examples of comparable representations may be found, for example, in the regions 29a and 29d from FIGS. 4 & 5 of DE 10 2015 002 438 A1 cited above.

However, the disclosed embodiments furthermore provide for using such a representation of surroundings for generating a comparatively large environment map of the transportation vehicle. To put it more precisely, the representation of surroundings generating device 18 is configured to combine generated representations of surroundings (or different regions of one representation of surroundings) for example, on the basis of location information explained above for the purpose of generating a (virtual or digital) environment map, to image a surroundings region of the transportation vehicle which is larger than a capture region of the sensors 12, 14 and comprises a plurality of meters (for example, at least 5 m or at least 10 m) in at least one dimension, for example. It is thus possible overall to generate a realistic and comparatively large environment map (or, to put it another way, a large-area composite representation of surroundings) which makes it possible to achieve a more precise representation and generally comprehensive information collection with regard to the surroundings. This can be used to display for a driver on a display device in the vehicle interior segments of the environment map which, in comparison with previous solutions, are larger, more realistic and/or, during travel and during delivery processes, are continuously updated and are also rapidly retrievable.

A further exemplary embodiment of the disclosed solution is explained below with reference to FIG. 1B. In FIG. 1B, a region 26 is marked which, from the point of view of the transportation vehicle 100 (or of the vehicle midpoint M), is positioned behind the raised region 24, that is to say behind that region of the projection screen 22 which corresponds to the curb 16.

The situation can occur that image information is not able to be captured by the camera devices 14 for such regions 26, since the latter are concealed by the raised structure (the curb 16 in this case). The fact of whether such potentially concealed regions 26 are present can be determined in a separate method operation. For this purpose, it is possible to have recourse to the information of the height profile, for example, to a locally captured height H, as is indicated for the projection screen 22 in the raised region 24 in FIG. 1B. If the height exceeds a minimum threshold value, it can be assumed that regions situated behind that from the point of view of the transportation vehicle are expected to be concealed and meaningful image information is not able to be determined therefor.

In principle, the height H shown can also be chosen to be significantly larger, e.g., as a kind of vertical boundary surface of the projection screen 22. For this case, projection onto the vertical boundary surface can be effected and determining concealed regions or providing separate filling information would not necessarily be required.

A determination and a special representation of concealed regions 26 are desired, however, in the embodiment shown. If a corresponding (potentially) concealed region 26 was determined (for example, by the representation of surroundings generating device 18 and, e.g., taking account of the information discussed above), for this region 26 of the projection screen 22 it is possible to stipulate that the representation of surroundings in precisely this region 26 is not generated on the basis of the captured image information. Instead, there it is possible to use predetermined (or, synonymously, predefined) filling information, e.g., predefined colors or patterns, which can signal the lack of image information to the driver. Alternatively, muted colors or simply black regions can also be predefined as filling information to direct the driver's attention to the image information that actually exists within the representation of surroundings and to not separately emphasize visually the lack of image information. In this way, too, the meaningfulness of the representation of surroundings is increased since unnatural distortions and/or an incorrect arrangement of image information within the representation of surroundings are/is less likely.

Corresponding processes can be carried out continuously during travel of the transportation vehicle 100, for example, along a travel distance of at least 5 m or at least 10 m. This distance goes beyond the capture regions of the sensors 12, 14, particularly in the case of a stationary transportation vehicle 100, by a multiple. On the basis of this, it is then possible, as explained above, to continuously supplement or compile an environment map and thus to create a kind of digital information collection with regard to the vehicle surroundings, which information collection is able to be imaged virtually.

FIG. 2 shows a flowchart for the method outlined above with reference to FIG. 1A, FIG. 1B, although a consideration of possibly concealed regions 26 is omitted.

As depicted, an operation at S1 involves capturing the vehicle surroundings by camera device(s) 12 and by sensor device(s) 14. The information is communicated to the representation of surroundings generating device 18 for evaluation. In an operation at S2, the representation of surroundings generating device determines an optionally 360° height profile of the vehicle surroundings. On the basis of this, the (virtual) projection screen 22 is produced in a operation at S3, in particular, by providing raised regions 24 of the projection screen 22 according to correspondingly raised structures in the height profile. In an operation at S4, the image information captured by the camera devices 12 is then projected onto the projection screen 22. The result can be represented on a display device in the vehicle interior in operation at S5.

It goes without saying that operation at S1 to S5 can be carried out repeatedly to permanently update the generated representation of surroundings. This is represented by a corresponding arrow from S5 to S1. Likewise, the operations can also be carried out partly in parallel. By way of example, when S3 is being carried out, renewed capturing of the surroundings in the sense of operation at S1 can already begin again or the capturing of surroundings can generally be effected continuously and without interruptions.

What is not illustrated separately is that in this way, during travel, an environment map with a larger area in comparison can also be compiled continuously from the respectively generated (and optionally displayed) representations of surroundings.

### LIST OF REFERENCE SIGNS

10 Arrangement
12 Camera device
14 Sensor device
16 Curb
18 Representation of surroundings generating device
20 Surface beneath the transportation vehicle
22 Projection screen
24 Raised structure
26 Concealed region
100 Transportation vehicle
M Vehicle midpoint
H Height

1. A method for generating a representation of surroundings of a transportation vehicle, the method comprising:
determining a height profile of vehicle surroundings;
capturing image information of the vehicle surroundings;
projecting the image information onto at least one part of a projection screen for generating the representation of surroundings, wherein the projection screen is produced in a raised state at least regionally in response to the height profile determined indicating a correspondingly raised structure of the vehicle surroundings; and
generating an environment map of the transportation vehicle based on the representation of surroundings, by which a surroundings region of the transportation vehicle is imaged which is larger than a capture region of sensors used for determining the height profile and/or the image information.

2. The method of claim 1, wherein the image information is captured by a plurality of sensors that comprise at least one vehicle-mounted camera.

3. The method of claim 1, wherein the height profile is generated at least partly based on information captured by the plurality of sensors that comprise at least one vehicle-mounted sensor.

4. The method of claim 3, wherein the sensor is one of the group comprising: a distance measuring device, a radar device, a lidar device, an ultrasonic device, an optical distance measuring device.

5. The method of claim 1, further comprising producing at least regional texture of the projection screen using the image information.

6. The method of claim 1, wherein, in at least one region of the projection screen, a texturing is effected using predetermined filling information instead of the image information.

7. The method of claim 1, wherein in at least one region of the projection screen situated behind a raised region of the projection screen from the point of view of the transportation vehicle, a texturing is effected using the predetermined filling information instead of the image information.

8. The method of claim 6, wherein the filling information comprises at least one of:
a predefined color;
a predefined pattern; or
a texturing predefinition for an object recognized in the at least one region.

9. An arrangement for generating a representation of surroundings of a transportation vehicle, the arrangement comprising:
at least one sensor for capturing information for generating a height profile of the vehicle surroundings;
at least one camera for capturing image information of the vehicle surroundings; and
a representation of surroundings generator configured to:
determine a height profile of the vehicle surroundings;
produce a projection screen for the representation of surroundings based on the height profile; and
project the image information onto at least one part of the projection screen for generating the representation of surroundings,
wherein the projection screen is produced in a raised state at least regionally in response to the height profile determined indicating a correspondingly raised structure of the vehicle surroundings, and
wherein the representation of surroundings generating device is configured for generating an environment map of the transportation vehicle based on the representation of surroundings, by which a surroundings region of the transportation vehicle is imaged which is larger than a capture region of the sensor and of the camera.

10. A transportation vehicle, comprising the arrangement of claim 9.

11. The arrangement of claim 9, wherein the image information is captured by a plurality of sensors that comprise at least one vehicle-mounted camera.

12. The arrangement of claim 9, wherein the height profile is generated at least partly based on information captured by the plurality of sensors that comprise at least one vehicle-mounted sensor.

13. The arrangement of claim 12, wherein the sensor is one of the group comprising: a distance measuring device, a radar device, a lidar device, an ultrasonic device, an optical distance measuring device.

14. The arrangement of claim 9, wherein the production of the at least regional texture of the projection screen is performed using the image information.

15. The arrangement of claim 9, wherein, in at least one region of the projection screen, a texturing is effected using predetermined filling information instead of the image information.

16. The arrangement of claim 9, wherein, in at least one region of the projection screen situated behind a raised region of the projection screen from the point of view of the transportation vehicle, a texturing is effected using the predetermined filling information instead of the image information.

17. The arrangement of claim 11, wherein the filling information comprises at least one of:
a predefined color;
a predefined pattern; or
a texturing predefinition for an object recognized in the at least one region.
